(19) United States
(12) Patent Application Publication
(10) Pub. No.: US 2007/0240545 A1
(43) Pub. Date: Oct. 18, 2007

(54) Positioning device for retractable handle of hand tool

(76) Inventor: Chun-Lang Lin, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/402,933

(22) Filed: Apr. 13, 2006

(51) Int. Cl. B25B 23/16; B25G 1/04

(52) U.S. Cl. 81/177.2

(57) ABSTRACT

A hand tool includes a function head connected to an end of a shank and a plurality of positioning slots are defined in an outer surface of the shank. An end section is mounted on the shank and a positioning collar is located between the shank and the end section. The positioning collar has a positioning portion which is engaged with one of the positioning slots in the shank. The positioning collar can be deformable radially inward and so as to be disengaged from the positioning slots. A biasing member biases the positioning collar toward the positioning slots.

### FIELD OF THE INVENTION

The present invention relates to a positioning device for secure a retractable handle of a hand tool.

### BACKGROUND OF THE INVENTION

A conventional hand tool includes a handle and a function head which is connected to one end of the handle and the other end of the handle has a grip so that the user holds the grip and rotates the handle to output a torque to the object to be tightened or loosened. The length of the handle relates the force that applied to the object so that a retractable handle is developed. The conventional retractable handle usually includes an inner tube and an outer tube, a positioning device is used to position the inner tube relative to the outer tube. The conventional positioning device includes a bead biased by a spring and the outer tube includes a plurality of positioning holes so that the bead is engaged with one of the positioning holes to position the inner tube relative to the outer tube. However, the bead cannot bear large force so that the bead slips out from hole often. Sometimes, the positioning hole is deformed by the bead.

The present invention intends to provide a positioning device for a retractable handle for a hand tool and includes a positioning collar which is retained in a sleeve and includes a positioning portion which is engaged with one of the slots in the shank.

### SUMMARY OF THE INVENTION

The present invention relates to a hand tool which comprises a function head connected to an end of a shank and an end section has a longitudinal passage defined therethrough in which the shank is inserted. A plurality of positioning slots are defined in an outer surface of the shank. A positioning collar is located between the shank and the end section 6, the positioning collar 3 being deformable radially inward and has a positioning portion which is engaged with one of the positioning slots in the shank. A biasing member biases the positioning collar toward the positioning slots.

The primary object of the present invention is to provide a positioning device for securely positioning the shank relative to the end section so that the positioning device is reliable when outputting a large torque.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view of the hand tool of the present invention;

FIG. 2 is an exploded view to show the positioning device of the hand tool of the present invention;

FIG. 3 is a perspective view to show the positioning device of the present invention;

FIG. 4 is a cross sectional view to show that the positioning collar is deformed inward and the positioning portion is disengaged from the positioning slots;

FIG. 5 shows that the positioning collar is pushed by the biasing member, and

FIG. 6 shows that the shank is positioned at another position relative to the end section.

### DETAILED DESCRIPTION OF THE PREFERRED EMBODIMENT

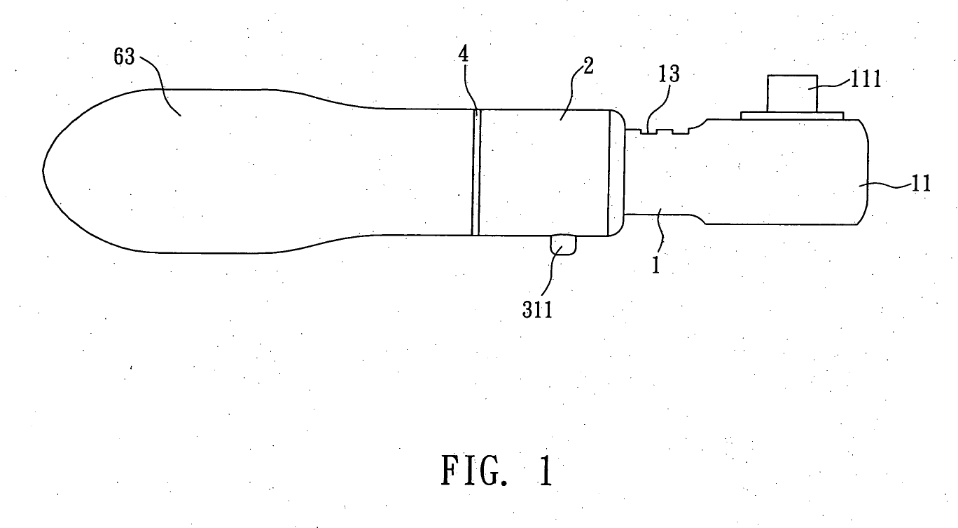

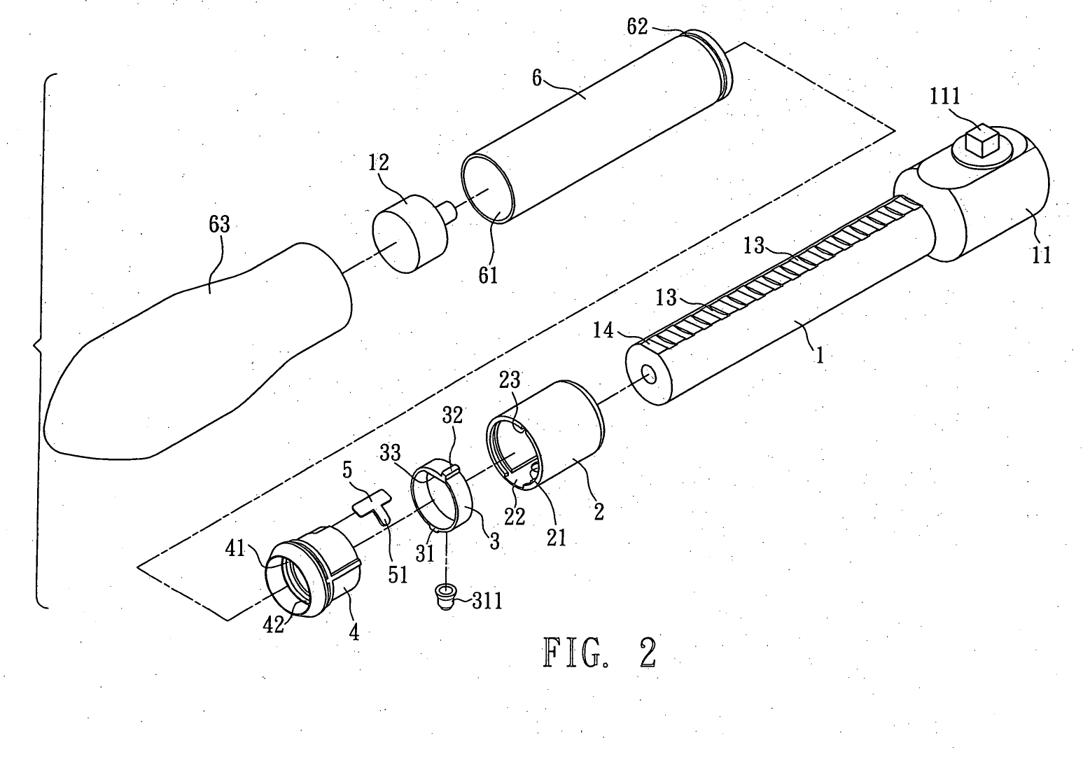

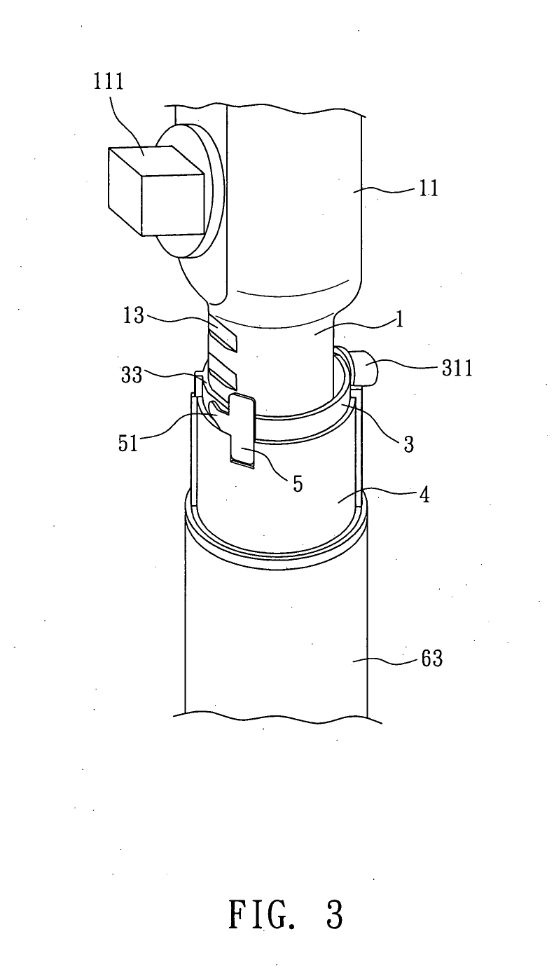

Referring to FIGS. 1 to 3, the hand tool of the present invention comprises a function head 11 connected to an end of a shank 1 and the shank 1 includes a plurality of positioning slots 13 defined in an outer surface thereof which can be a flat surface. The function head 11 includes a ratchet driving protrusion 111.

A retractable handle of the hand tool includes a first sleeve 2 mounted on the shank 1 and includes an aperture 21 defined through a wall thereof. A first groove 22 and a second groove 23 are respectively defined longitudinally in an inner periphery of the first sleeve 2. The aperture 21 communicates with the first groove 22. A positioning collar 3 is received in the first sleeve 2 and has a protrusion 31 and a ridge 32 extending from an outer periphery thereof. The protrusion 31 extends through the aperture 21 and the ridge 32 is slidably engaged with the second groove 23. The protrusion 31 of the positioning collar 3 is connected with a button 311 so that the positioning collar 3 is deformed inward by pushing the button 311.

A second sleeve 4 has a first end inserted into the first sleeve 2 and is mounted on the shank 1. By the second sleeve 4, the positioning collar 3 does not drop from the first sleeve 2. The second end of the second sleeve 4 has a stop flange 41 and a first engaging portion 42 defined in an inner periphery thereof. An end piece 12 is stopped by the stop flange 41 and connected to the other end of the shank 1. An end section 6 which has a longitudinal passage 61 defined therethrough and the shank 1 is inserted into the passage 61. A first end of an end section 6 has a second engaging portion 62 which is engaged with the first engaging portion 42. A grip 63 is connected to the second end of the end section 6.

A T-shaped biasing member 5 is a plate and two ends of the transverse section of the biasing member 5 are connected to the first and second sleeves 2, 4. A flexible tongue 51 extends from transverse section of the plate and presses the positioning portion 33 toward the shank 1 so that the positioning portion 33 of the positioning collar 3 is engaged with one of the positioning slots 13 of the shank 1.

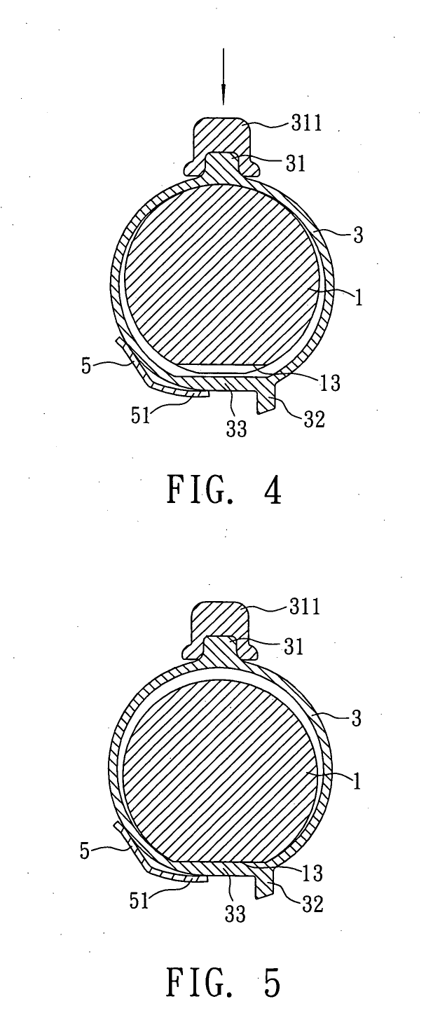

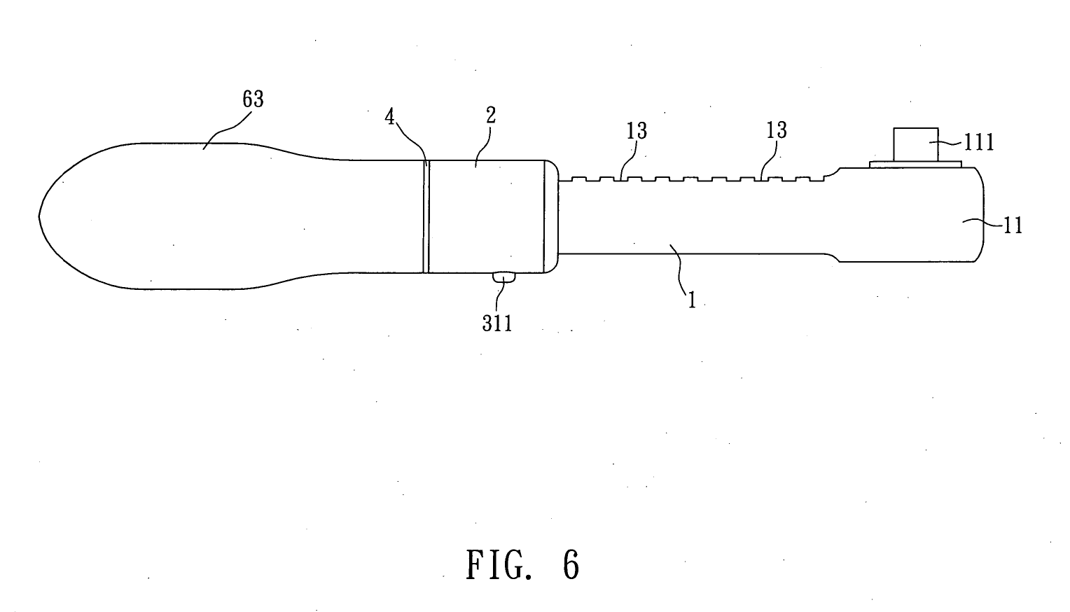

Referring to FIGS. 4, 5 and 6, when adjusting the length of the retractable handle of the hand tool, the user simply pushes the button 311 to make the positioning collar 3 deform radially inward such that the positioning portion 33 is disengaged from the positioning slot 13 and the user can pull the shank 1 freely to a desired position. The button is then released to let the positioning portion 33 be engaged with another positioning slot 13. The biasing member 5 is then pushed the positioning portion 33 to engage with the positioning slot 13. The shape of the positioning portion 33 and the positioning slots 13 can be made to have specific shapes so that the user does not need to press the button during adjustment. The positioning portion 33 is an elongate portion and the positioning slots 13 are elongate slots so that the engagement is much reliable than the conventional engagement between a bead and an aperture. Therefore, the retractable handle of the hand tool of the present invention can bear large torque without worry of disengagement between the positioning portion 33 and the positioning slot 13.

While we have shown and described the embodiment in accordance with the present invention, it should be clear to those skilled in the art that further embodiments may be made without departing from the scope of the present invention.

What is claimed is:

1. A hand tool comprising:
a function head connected to an end of a shank and a plurality of positioning slots defined in an outer surface of the shank;
an end section having a longitudinal passage defined therethrough and the shank inserted into the passage;
a positioning collar located between the shank and the end section, the positioning collar being deformable radially inward and having a positioning portion which is engaged with one of the positioning slots in the shank, and
a biasing member biasing the positioning collar toward the positioning slots.

2. The hand tool as claimed in claim 1, wherein the function head includes a ratchet driving protrusion.

3. The hand tool as claimed in claim 1, wherein a first sleeve is mounted on the shank and the positioning collar is movably received in the first sleeve, a second sleeve has a first end inserted into the first sleeve and the second sleeve is mounted on the shank, the biasing member is connected to the first and second sleeves.

4. The hand tool as claimed in claim 3, wherein the first sleeve includes an aperture defined through a wall thereof, a first groove and a second groove are respectively defined in an inner periphery of the first sleeve, the aperture communicates with the first groove, the positioning collar has a protrusion and a ridge, the protrusion extends through the aperture and the ridge is slidably engaged with the second groove, the end section has a first end connected to a second end of the second sleeve.

5. The hand tool as claimed in claim 4, wherein the second end of the second sleeve has a stop flange and a first engaging portion, an end piece is stopped by the stop flange and connected to the other end of the shank, the first end of the end section has a second engaging portion which is engaged with the first engaging portion.

6. The hand tool as claimed in claim 4, wherein the protrusion of the positioning collar is connected with a button so that the positioning collar is deformed inward by pushing the button.

7. The hand tool as claimed in claim 4, wherein the biasing member is a plate and two ends of the plate are respectively connected to the first and second sleeves, a flexible tongue extends from the plate and pressing the positioning portion toward the shank.

8. The hand tool as claimed in claim 4, wherein a grip is connected to the second end of the end section.

9. The hand tool as claimed in claim 1, wherein the outer surface of the shank includes a flat surface and the positioning slots are defined in the flat surface.

10. The hand tool as claimed in claim 1, wherein the positioning portion is an elongate portion and the positioning slots are elongate slots.
